(19) United States
(12) Patent Application Publication
(10) Pub. No.: US 2009/0232946 A1
(43) Pub. Date: Sep. 17, 2009

(54) EDIBLE PANEL FOR BUILDING A SELF INTERLOCKING MODEL AND SELF INTERLOCKING MODEL KIT COMPRISING THE EDIBLE PANEL

(76) Inventor: Yoo-Seun Cha, Gyeonggi-do (KR)

Correspondence Address: CANTOR COLBURN, LLP, 20 Church Street, 22nd Floor, Hartford, CT, 06103, US

(21) Appl. No.: 11/721,227

(22) PCT Filed: Dec. 8, 2004
(86) PCT No.: PCT/KR2005/004181

§ 371 Date: Jun. 8, 2007

(30) Foreign Application Priority Data
Dec. 8, 2004 (KR) 20-2004-0034908

(51) Int. Cl. A23G 3/50

(52) U.S. Cl. 426/104

(57) ABSTRACT

The present invention relates to an edible panel for building a self-interlocking model and a self-interlocking model kit comprising the same edible panel(s), in which the edible panel can be freely molded when it is in a dough state but is transformed into a cookie which is not be deformed or molded after calcining, wherein the edible panels are manufactured into a variety of shapes so that they can be assembled into a variety of models, such as a house model or a ship model, and a user can eat the edible panels after assembling them into a model and baking it, as well as have an experience of assembling the self-interlocking model kit into a self-interlocking model, and appreciating the model assembled by himself or herself using the self-interlocking model kit. The user further can use the self-interlocking model kit comprising the edible panels as celebration gifts. The edible panel for a self-interlocking model kit, according to the present invention has, at least one first coupling projection with a letter “L” shape.

### TECHNICAL FIELD

The present invention relates to an edible panel for building a self-interlocking model and a self-interlocking model kit comprising the same edible panel(s). More particularly, the present invention relates to an edible panel and a self-interlocking model kit comprising the same edible panel(s), in which the edible panel can be freely molded when it is in a dough state but is transformed into a hard cookie after calcining, in which it is not deformed or molded, wherein the edible panels are manufactured into a variety of shapes so that they can be assembled into a variety of models, such as a house model or a ship model, and a user can eat the edible panels after assembling them into a model and baking it, as well as have an experience of assembling the self-interlocking model kit into a self-interlocking model, thereby feeling a sense of achievement. That is, with the edible panels constituting a self-interlocking model kit, a user can have an experience of assembling a self-interlocking model kit, appreciate the model assembled by himself or herself using the self-interlocking model kit, and use the self-interlocking model kit comprising the edible panels as celebration gifts.

### BACKGROUND ART

Generally, people gather on special days, such as a birthday or Christmas, and enjoy special foods such as cakes or cookies on that day. As the special foods, a cake is generally used, but sometimes cookies with appearance of a variety of features can also be used.

Conventional cookies with appearance of a variety of features are generally manufactured and sold as finished goods with icing. Or, some conventional cookies are sold as assemblies, but it is difficult and it takes a long time to assemble the cookie assemblies because gluing is needed to assemble the cookie assemblies.

Accordingly, there has been a need to develop an edible panel and a self-interlocking model kit comprising the edible panels, in which a user can easily assemble the self-interlocking model kit into an edible model by just interlocking assemblies of the self-interlocking model kit. With the self-interlocking model kit comprising the edible panels, a user can have special cookies as well as have an experience of assembling a self-interlocking model kit, feeling a sense of achievement and satisfaction through the assembly work.

### DISCLOSURE

### Technical Problem

Accordingly, the present invention has been made keeping in mind the above problems occurring in the prior art and to solve a problem in which a user has only limited satisfaction: appreciating the appearance of a cookie provided as complete goods, and an object of the present invention is to provide an edible panel and a self-interlocking model kit comprising the same edible panels, the self-interlocking model kit giving a user a sense of satisfaction of creative work and a sense of achievement as well as a sense of satisfaction from the viewpoint of having food.

Another object of the present invention is to solve a problem of conventional model cookies, which are manufactured in a small volume as complete goods in which decoration is already finished and sold at high price, or which can be assembled with difficulty even if they are sold as assemblies because assembly thereof necessitates gluing. Accordingly, another object of the present invention is to provide an edible panel and a self-interlocking model kit comprising the edible panels, that can be easily manufactured at a large volume by using a mold cast so that people can easily use the self-interlocking model kit from the aspects of price as and volume, and further can be easily assembled by ordinary people.

A further object of the present invention is to provide an edible panel and a self-interlocking model kit comprising the edible panels, in which people can have an experience of assembling the self-interlocking model kit and decorating a model produced by assembling the self-interlocking model kit as they want, thereby being satisfied with their desired decoration.

### Technical Solution

In order to achieve the above objects, according to one aspect of the present invention, there is provided an edible panel having at least one first coupling projection with a letter “L” shape.

According to another aspect of the present invention, there is provided a self-interlocking model kit comprising a first edible panel having at least one first coupling projection with a letter “L” shape, and a second edible panel having at least one coupling hole which can be mated with the first coupling projection.

According to a further aspect of the present invention, there is provided a self-interlocking model kit comprising the first edible panel having at least one first coupling projection with a letter “L” shape, the second edible panel having at least one coupling hole which can be mated with the first coupling projection, a first coupling portion including at least two projections and notches formed between the projections, and a second coupling portion including at least two projections and notches formed between the projections, wherein the second coupling portion can be mated with the first coupling portion.

### ADVANTAGEOUS EFFECTS

As is apparent from the above descriptions, the edible panel can be freely molded when it is in a dough state, but is transformed into a cookie which is not deformed or molded, by calcining, in which the edible panel has a variety of sizes and shapes so as to be molded into a variety of models, such as a house or a ship, so that it gives people a chance to experience modeling, appreciate the model built by themselves, feel a sense of achievement and satisfaction, and have special cookies with unique appearance designed by themselves, which can be used as celebration gifts.

### DESCRIPTION OF DRAWINGS

FIG. 1 is a schematic view illustrating an edible panel for building a self-interlocking model kit according to one embodiment of the present invention;

FIG. 2 is a schematic view illustrating an edible panel for building a self-interlocking model kit according to another embodiment of the present invention;

FIG. 3 is a schematic view illustrating an edible panel for building a self-interlocking model kit according to further another embodiment of the present invention;

FIG. 4 is a schematic view illustrating an edible panel for a self-interlocking model kit according to still further embodiment of the present invention;

FIG. 5 is a view illustrating the status in which edible panels according to the embodiments of the present invention are combined with each other;

FIG. 6 is a schematic view illustrating an edible panel included in a self-interlocking model kit according to one embodiment of the present invention;

FIG. 7 is a schematic view illustrating an edible panel included in the self-interlocking model kit according to one embodiment of the present invention;

FIG. 8 is a schematic view illustrating an edible panel included in the self-interlocking model kit according to one embodiment of the present invention;

FIG. 9 is a view illustrating the status in which the edible panels shown in FIG. 7 and FIG. 8 are combined;

FIG. 10 is a view showing a method of coupling edible panels in a self-interlocking model kit according to one embodiment of the present invention;

FIG. 11 is a perspective view illustrating the coupled status of the edible panels shown in FIG. 10;

FIG. 12 is a perspective illustrating a completed model produced by assembling the edible panels in a self-interlocking model kit according to one embodiment of the present invention;

FIG. 13 is an exploded view illustrating the edible panels which are not yet coupled, according to one embodiment of the present invention;

FIG. 14 is a perspective view illustrating the coupled status of the edible panels shown in FIG. 13;

FIGS. 15 to 21 are photographs showing the sequence of assembling the edible panels constituting a self-interlocking model kit according one embodiment of the present invention;

FIG. 22 is a photograph showing a self-interlocking model produced according to the assembly sequence shown in FIGS. 15 to 21;

FIG. 23 is a photograph showing a method of making a fence model by assembling third-type edible panels;

FIG. 24 is a photograph illustrating the fence model produced by the method shown in FIG. 23;

FIG. 25 is a photograph illustrating a completed model with icing, produced by assembling edible panels in a self-interlocking model kit according to one embodiment of the present invention;

FIG. 26 is a photograph illustrating a method of icing the edible panels constituting a self-interlocking model kit according to the one embodiment of the present invention;

FIG. 27 is a photograph illustrating a ship model produced by assembling edible panels of a self-interlocking model kit according to one embodiment of the present invention; and

FIGS. 28 and 29 are photographs illustrating the completed ship models with icing, produced by using the self-interlocking model kit according to the one embodiment of the present invention.

### BEST MODE

Hereafter, embodiments of the present invention will be described with reference to the accompanying drawings.

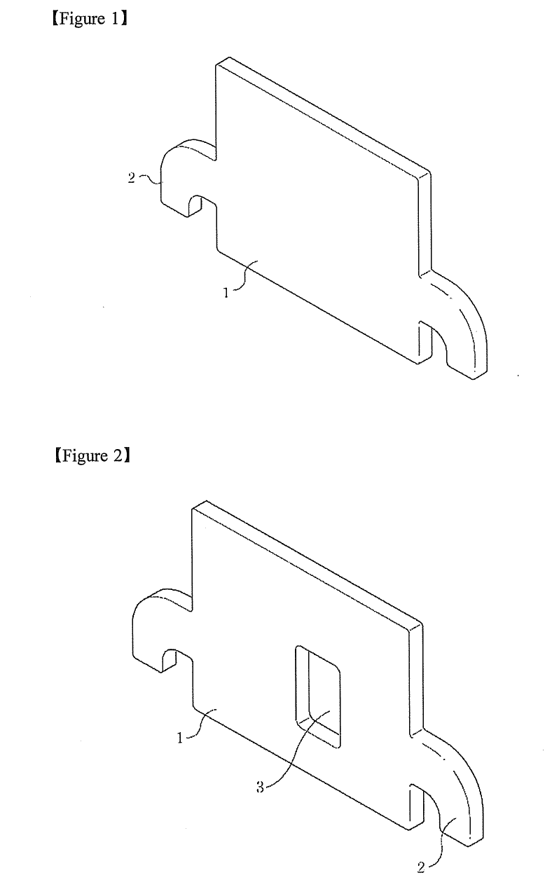

As shown in FIG. 1, an edible panel according to one embodiment of the present invention comprises a main body 1 and one or more first coupling projections 2 projected from side edges of the main body 1. The first coupling projection 2 has a letter “L” shape. For the sale of convenience of description, the first coupling projection 2 is described to have a letter “L” shape, but a bent portion of the first coupling projection 2 can be actually rounded instead of having the right angle, as shown in FIG. 1. Since the bent portion of the first coupling projection 2 is rounded, the first coupling projection 2 can be easily inserted into a coupling hole, which will be described below. Actually, since the cookies are deformed during baling, it is difficult to maintain a right angle in the bent portion. Further, even if the bent portion of the first coupling projection 2 has the right angle, an outer corner edge of the right angle can be easily smashed by external impact. Accordingly, the bent portion of the first coupling projection 2 is preferably rounded. The first coupling projection is characterized by the rounded bent portion in this invention. The first coupling projection 2 is formed to have the reversed letter “L” shape, and is designed to be kept fixed on the status in which an end of the first coupling projection 2 is inserted into the coupling hole 3. The edible panel has adequate mechanical strength to maintain a predetermined shape, like a cookie, for example a balked biscuit, which is made by mixing ingredients of flour, which is the main ingredient, sugar, milk, egg and spices. The edible panel further can be formed by casting melted chocolate into a mould, and solidifying the melted chocolate. FIG. 1 illustrates the edible panel comprising the main body 1 and the first coupling projection 2, and FIG. 2 illustrates an edible panel comprising a main body 1, a first coupling projection 2 and a coupling hole 3. Accordingly, the edible panels are assembled as the first coupling projection 2 formed at a side of a main body is inserted into the coupling hole formed in a different main body.

The first coupling projection 2 and the coupling hole 3 are formed to have corresponding sizes and shapes so that they can be engaged with each other.

The edible panel further has at least one coupling hole 3 to receive the first coupling projection 2 therein. Two or more edible panels are combined as the coupling hole 3 is mated with the first coupling projection 2, so that the edible panels stay combined and do not fall down while the edible panels are assembled. As described above, since the first coupling projection 2 has a letter “L” shape, once the first coupling projection 2 is inserted into the coupling hole 3, the outer corner edge of the bent portion of the first coupling projection 2 is stopped by the peripheral of the coupling hole 3, and the first coupling projection 2 is not separated from the coupling hole 3. Accordingly, the edible panels can be easily combined with each other and can stay combined once they are combined with each other. On the other hand, the coupling hole 3 has a size slightly larger than that of the first coupling projection 2 so that the first coupling projection 2 can be easily inserted into the coupling hole 3. Accordingly, the first coupling projection 2 can be easily mated with the coupling hole 3. Due to this reason, assembling a model is easy, even though the edible panels are weak against external impact or pressure and brittle, and the model is not easily broken during assembly since the first coupling projection 2 can be easily engaged with the coupling hole 3.

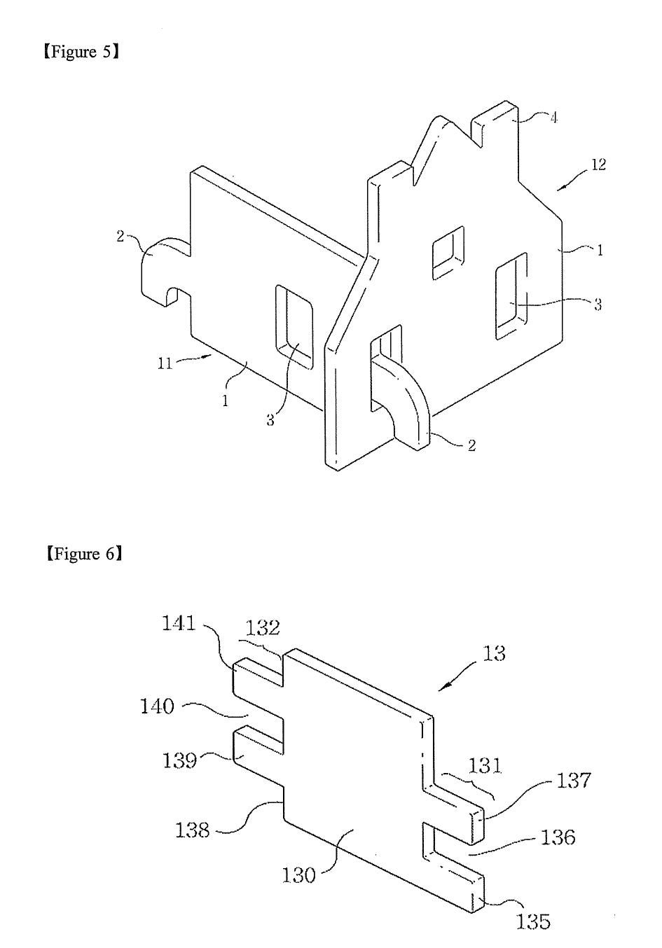

The first coupling projection 2 and the coupling hole 3 are formed at corresponding positions, and the number of the coupling projections 2 and the coupling holes 3 is determined based on the number of edible panels to be combined. As shown in FIG. 5, when two edible panels, which comprises a first edible panel 11 and a second edible panel 12, are combined, the first coupling projection 2 of the first edible panel 11 is inserted into the coupling hole 3 of the second edible panel 12 and fixed in the coupling hole 3, so that the first edible panel 11 and the second edible panel 12 do not fall down. At this time, a position of the coupling hole 3 of the second edible panel 12 corresponds to a position of the first coupling projection 2 of the first edible panel 11 such that bottoms of the first and second edible panels 11 and 12 are in touch with the base surface when the first edible panel 11 and the second edible panel 12 are combined. Another first coupling projection 2 of the first edible panel 11 can certainly be inserted into the coupling hole 3 of another edible panel.

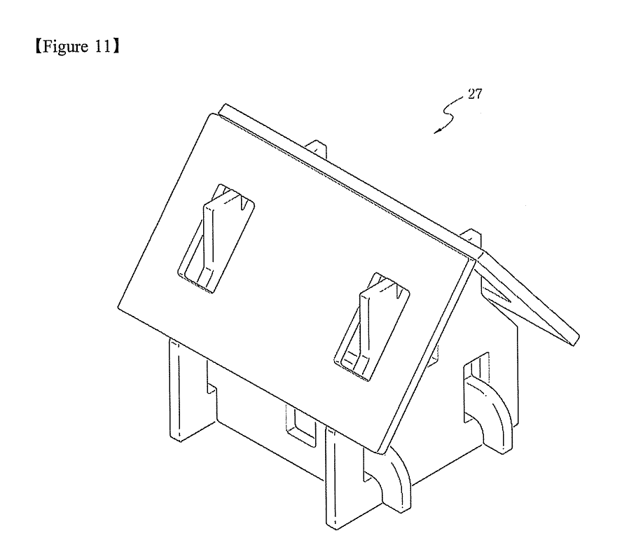

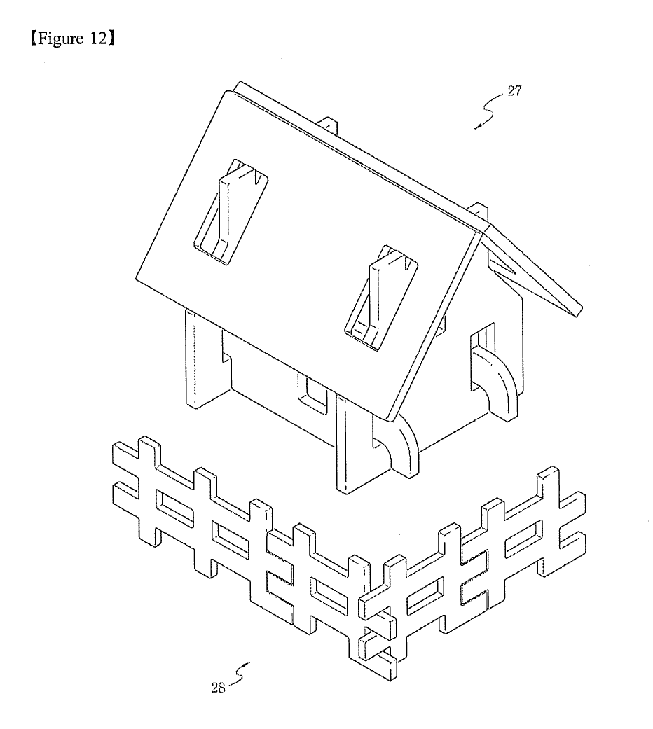

The first coupling projection 2 can be formed at an edge portion of the edible panel, so that an outline of a model can be easily constructed. In the case in which the model is a house, as shown in FIG. 10, a model kit comprises two side walls 21 and 22, a front wall 23, a rear wall 24, and two roof panels 25 and 26. Each of the edible panels serving as the two side walls 21 and 22 has two first coupling projections 2. Each of the edible panels serving as the front wall 23 and the rear wall 24 has two coupling holes 3 and two first coupling projections 2. Each of the two edible panels serving as the roof 25 and 25 has two coupling holes 3. As the first coupling projections 2 are mated with the coupling holes 3, the model house can be built.

As shown in FIG. 4, the edible panel can have a second coupling projection 4, which is different from the first coupling projection 2 in shape. The second coupling projection 4 is generally disposed at the top of the edible panel. That is, the second coupling projection 4 is disposed at a position where the second projection 4 is not separated from the coupling hole 3 even though it does not have a bent portion. According to one embodiment of the present invention, the second coupling projection 4 is rectangular or square, but the shape of the coupling projection 4 is not limited thereto. That is, the requirements of the second projection 4 are a position and a size by which the second projection 4 is not separated from the coupling hole 3. That is, as shown in FIG. 10, as the second coupling projection 4, formed at the top of the front wall 23, is inserted into the coupling hole 3 of a first roof panel 25, the first roof panel 25 is fixed on the top of the front wall 23. At this time, the front wall 23 keeps standing erect since it is combined with a first side wall 21, and the first roof panel 25 does not slip even though the second coupling projection 4 is just inserted into the coupling hole 3 of the first roof panel 25. Accordingly, the first roof panel 25 can be maintained on the top of the front wall 23.

The second coupling projection 4 is also formed at an edge portion of the edible panel, so that, as shown in FIG. 11, a model, such as a house, can be easily built.

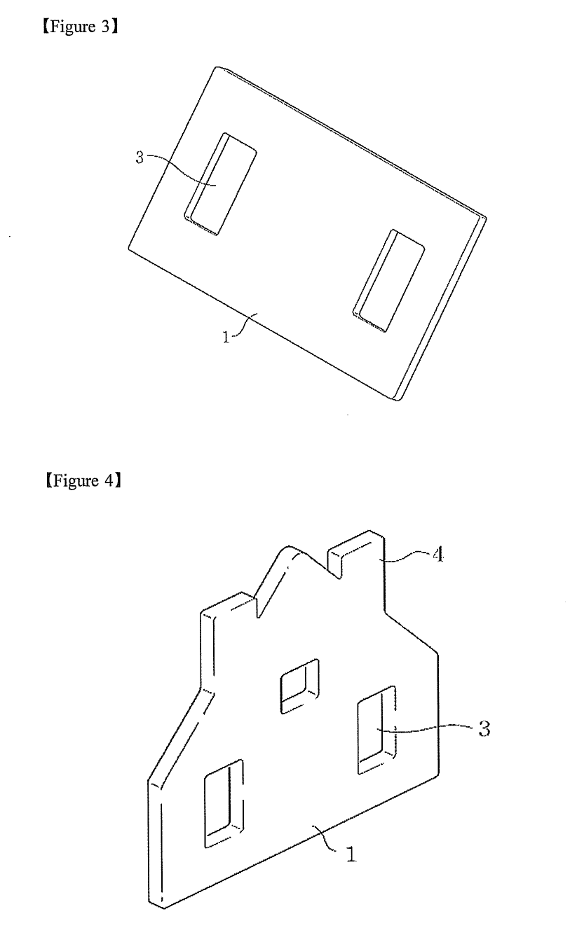

A self-interlocking model kit according to one embodiment of the present invention includes a first edible panel 11 having at least one first coupling projection 2 having a letter “L” shape, and a second edible panel 12 having at least one coupling hole 3. The first edible panel 11 having the first coupling projection 2 is the same as or a similar to the edible panels shown in FIGS. 1 and 2, and the second edible panel 12 having the coupling hole 3 is the same as or similar to the edible panels shown in FIGS. 2 and 3. Further, the edible panel shown in FIG. 5 can be used for a self-interlocking model kit.

The self-interlocking model kit can include an edible panel having only the coupling hole 3, shown in FIG. 3. The edible panel shown in FIG. 3 can be used as a finishing panel, such as a roof panel, as shown in FIGS. 10 and 11.

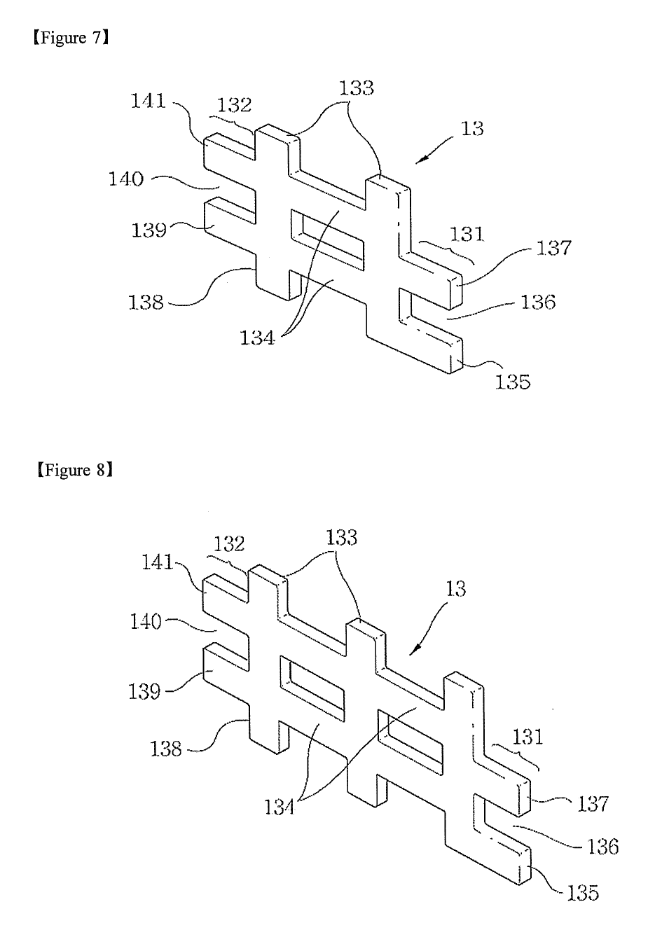

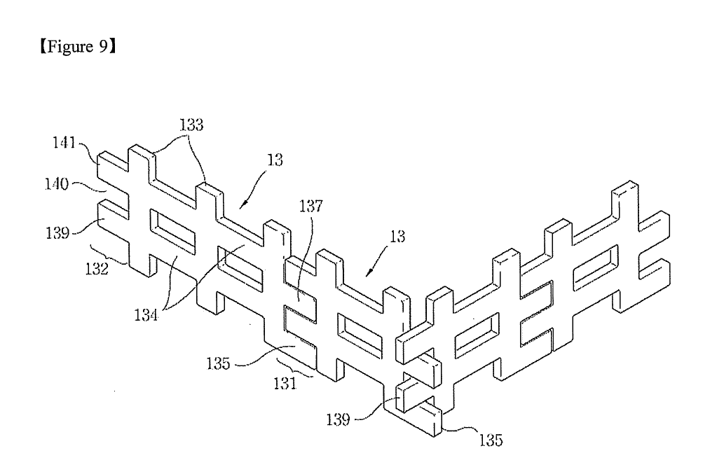

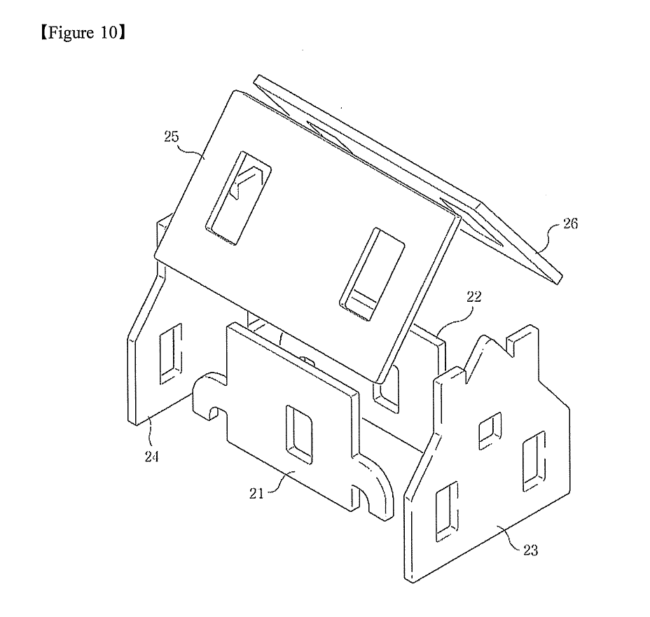

A self-interlocking model kit according to another embodiment of the present invention includes a first edible panel 11 having at least one first coupling projection 2 having a letter “L” shape, a second edible panel 12 having at least one coupling hole 3, and a third edible panel 13 having a first coupling portion 131 comprising a first projection 135, a first notch 136 and a second projection 137, and a second coupling portion 132 comprising a first coupling jaw 138, a third projection 139, a second notch 140 and a fourth projection 141. The third edible panel is the same as or similar to the edible panels shown in FIGS. 6 to 8. Referring to FIG. 6, the third edible panel 13 comprises a flat body 130, a first coupling portion 131 and a second coupling portion 132. The first coupling portion 131 and the second coupling portion 132 are provided on both sides of the flat body 130, respectively. Each of the first coupling portion 131 and the second coupling portion 132 includes at least two projections. That is, the first coupling portion comprises a first projection 135, a first notch 136, and a second projection 137 which are disposed in order from the bottom. The second coupling portion 132 comprises a coupling jaw 138, a third projection 139, a second notch 140, and a fourth projection 141. Accordingly, when a fence model is built by engaging the first coupling portion 131 and the second coupling portion 132, the first projection 135 of the first coupling portion 131 is interlocked with the coupling jaw 138 of the second coupling portion 132, and the third projection 139 of the second coupling portion 132 is interlocked with the first notch 136 of the first coupling portion 131. Further, the second projection 137 of the first coupling portion 131 is interlocked with the second notch 140 formed above the third projection 139, and the fourth projection 141 of the second coupling portion 132 is disposed above the second projection 137. Since the third edible panels are coupled as described above, the fence model can stand erect by itself. Particularly, the first projection 135 interlocked with the coupling jaw 138 has a bottom, which is in touch with a base surface. Accordingly, the model fence can easily stand due to a large area of the bottom of the first projection 135. As shown in FIGS. 7 and 8, the third edible panel 13 has at least two vertical poles 133 and at least one horizontal pole 134. One of the vertical poles has at least two projections. That is, the one vertical pole has a first coupling portion 131 comprising a first projection 135, a second projection 137 and a first notch 136 formed between the first and second projections 135 and 137. The other vertical pole has at least two projections. That is, the other vertical pole has a second coupling portion 132 comprising a third projection 139, a fourth projection 141, a second notch 140 formed between the projections 139 and 141, and a coupling jaw 138. Preferably, there are two horizontal poles 134. As shown in FIG. 8, in the case in which a distance between the first coupling portion 131 and the second coupling portion 132 is long, the number of vertical poles 133 is increased to three or more. Due to the combination between the first and second coupling portions 131 and 132, two or more third edible panels 13 can be connected to form a long fence model 28 as shown in FIG. 9. In the fence model 28 shown in FIG. 9, three third edible panels 13 shown in FIG. 7 and one third edible panel 13 shown in FIG. 8 are connected, in which the four third edible panels are coupled such that the first coupling portion of any one the third edible panels is engaged with the second coupling portion of another third edible panel.

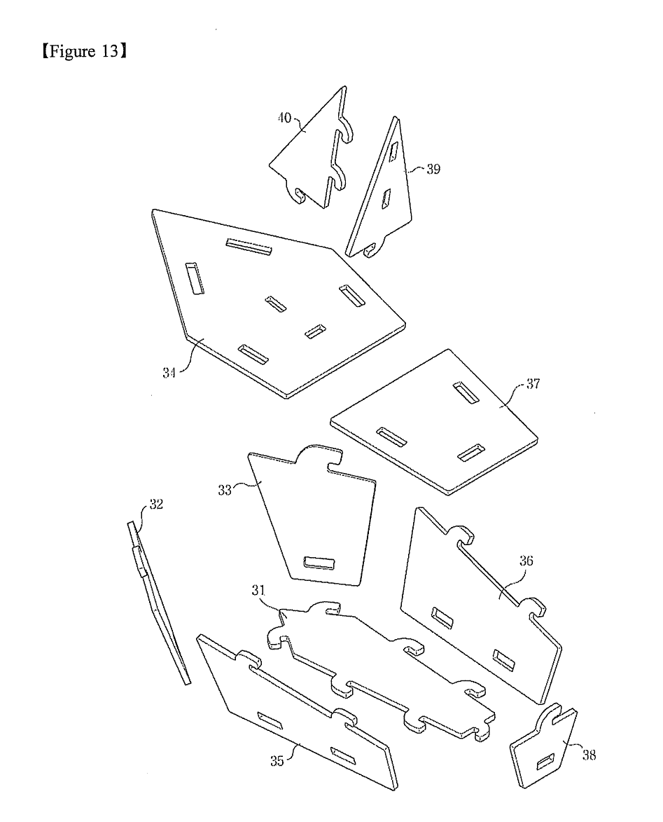

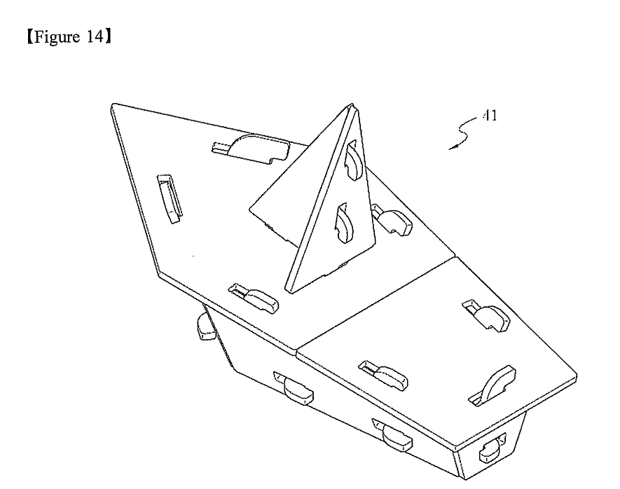

A self-interlocking model kit comprising edible panels, according to the present invention, can be either custom-designed or designed by a manufacturer. That is, the self-interlocking model kit can produce a house model as shown in FIG. 11. The house model can be assembled by using the edible panels shown in FIGS. 9 and 10, but also can be assembled by using other types of edible panels. Further, the self-interlocking model kit for producing the house model can be assembled into a different model. That is, the edible panels included in the self-interlocking model kit shown in FIG. 13 can be assembled into a ship model 41 shown in FIG. 14. The self-interlocking model kit for the ship model 41 comprises a bottom panel 31, a first bow panel 32, a second bow panel 33, a first deck panel 34, a first side panel 35, a second side panel 36, a second deck panel 37, a stem panel 38, a sail panel 39 and a mast panel 40. The front half of the ship model is assembled such that the first coupling projections formed at the front edge of the bottom panel 31 are inserted into the coupling holes of the first bow panel 32 and the second bow panel 33, and the first coupling projections of the first bow panel 32 and the second bow 33 panel are inserted into the coupling holes of the first deck panel 34. The front half of the ship model assembled as described above does not collapse, but can be kept in the status in which it is assembled. Continuously, the first coupling projections formed on both sides of the bottom panel 31 are inserted into the coupling holes of the first side panel 35 and the second side panel 36. Sides of the ship model are assembled such that the first coupling projections of the first side panel 35 and the second side panel 36 are inserted into the coupling holes of the second deck 37. Finally, the stem panel 38 is coupled to complete the ship model by inserting the first coupling projections of the stem panel 38 into the coupling holes of the second deck panel 37. Further, the sail panel 39 is fixed to the first deck panel 36 such that the first coupling projection of the sail panel 39 is inserted into the coupling hole formed in the first deck panel. The first coupling projections of the mast panel 40 are inserted into the coupling holes of the first deck panel 36 and the sail panel 39, thereby finishing assembly of the ship model.

The self-interlocking model kit according to the present invention can be assembled into a variety of models as well as the house model and ship model. That is, the model produced by the self-interlocking model kit is not limited to the house model or the ship model. It is apparent that a variety of models can be produced by using the edible panels having the first coupling projections according to the present invention.

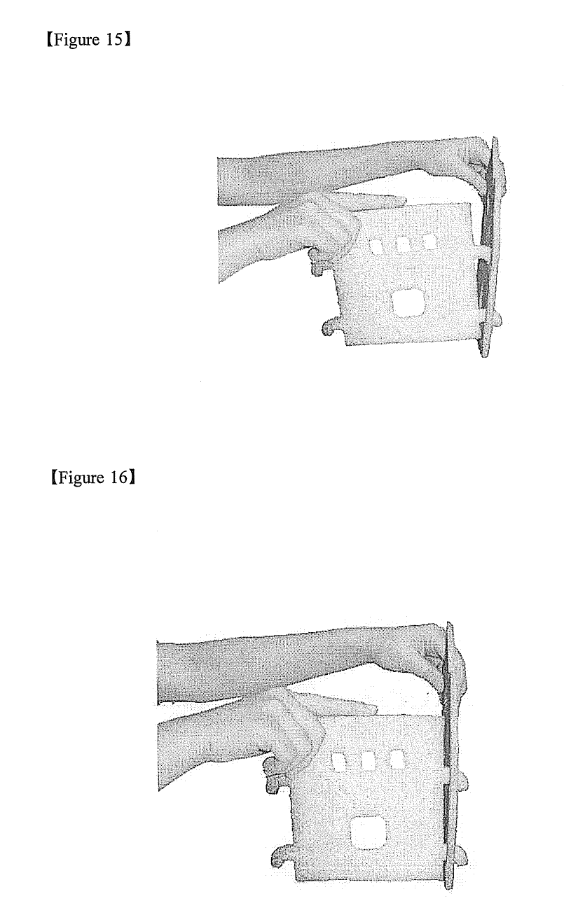

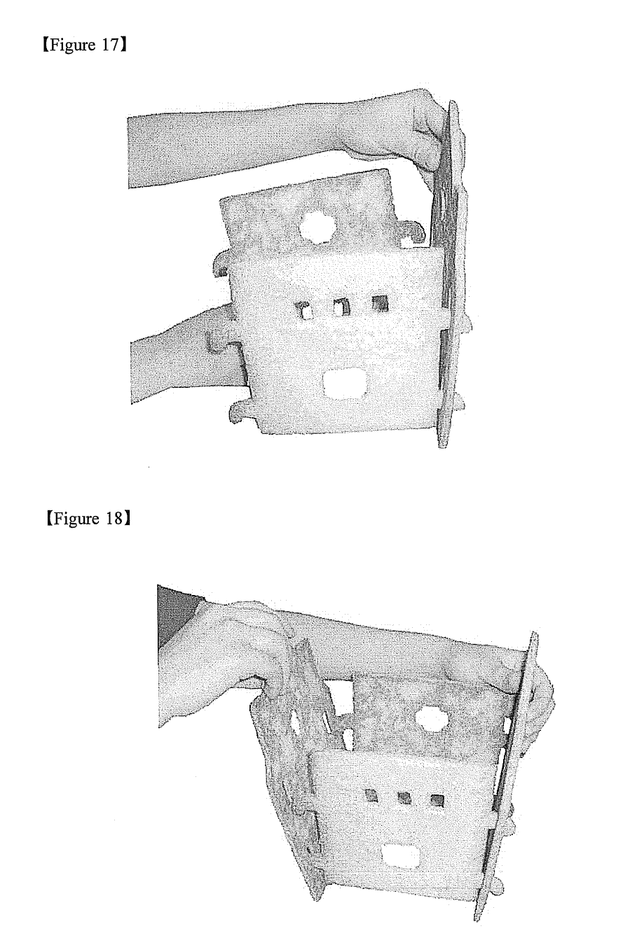

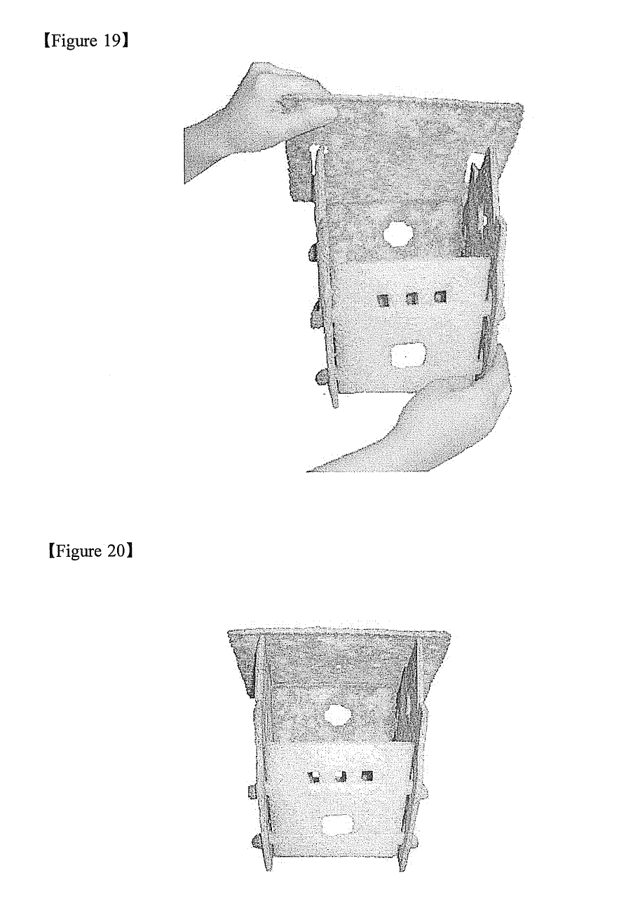

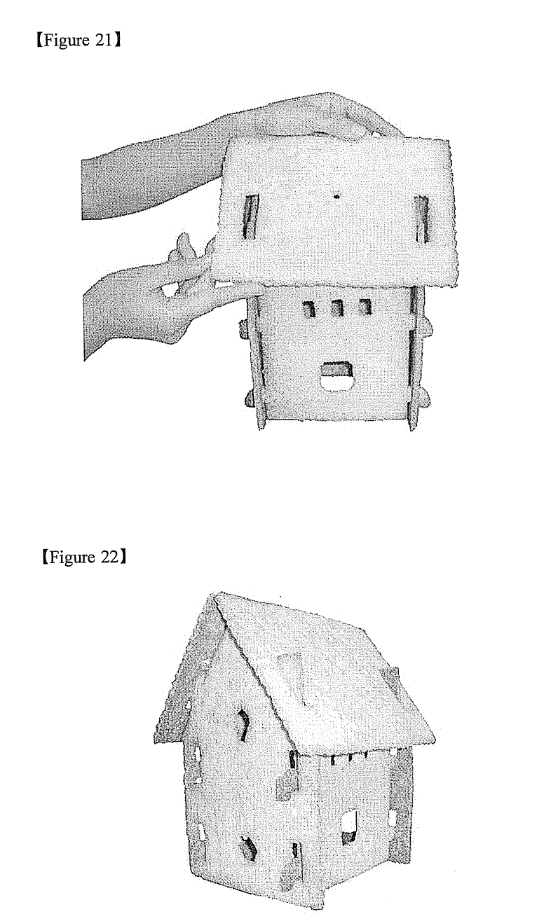

FIGS. 15 to 21 are photographs showing the sequence of actually assembling the edible panels into a house model after baling the edible panels, so as to be transformed to biscuits. As shown in FIGS. 15 to 21, even though only two edible panels are assembled, the edible panels can stand by themselves while they are assembled.

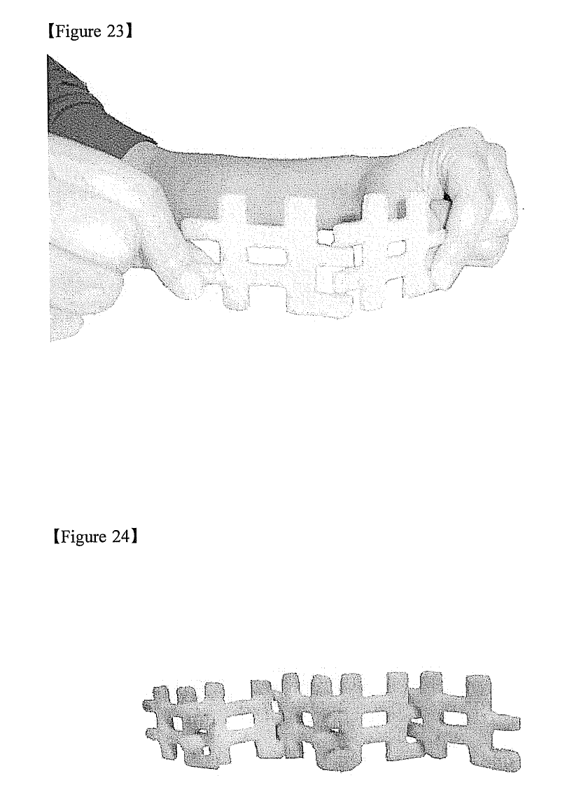

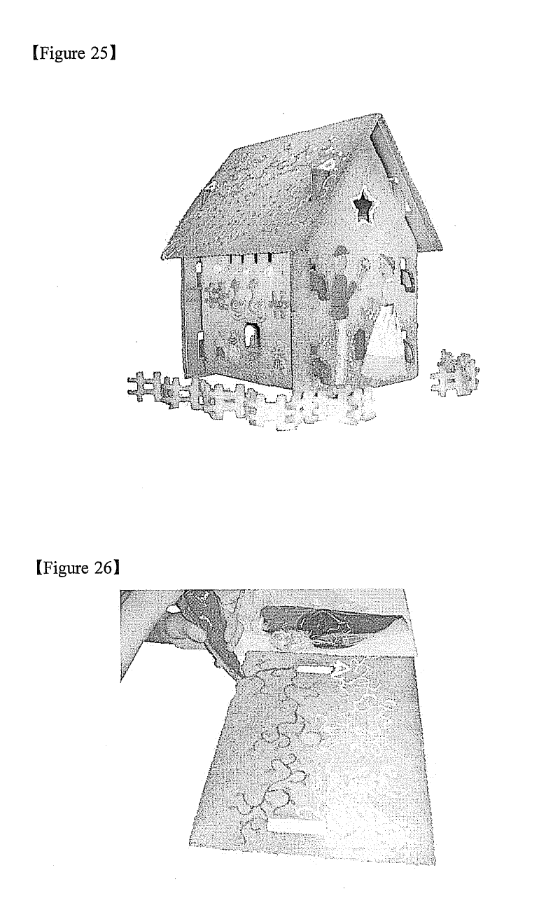

FIG. 22 is a photograph showing the house model produced according to the assembly sequence shown in FIGS. 15 to 21. It is found that a house model is produced by using the edible panels constituting a self-interlocking model kit according to the present invention. FIG. 23 is a photograph showing a method of making a fence model using the third edible panels in the self-interlocking model kit. FIG. 24 is a photograph illustrating the completed fence model by the method shown in FIG. 23. As shown in FIGS. 23 and 24, a fence model can be produced by using the third edible panels according to the present invention. As shown in FIG. 25, as the house model and the fence model are displayed together, a higher level of work can be implemented.

The models, such as the house model or the ship model, can be decorated with cream or chocolate. Icing can be formed by filling a squeeze bottle with a material for cake icing, such as cream or chocolate, and squeezing the cake icing material. Since the icing material can be easily dyed a variety of colors, it is apparent that a variety of icings can be implemented with the icing material. An example of the iced model is shown in FIG. 25. A method of icing a model is shown in FIG. 26. By using a conventional squeeze bottle, a high level of work. can be produced.

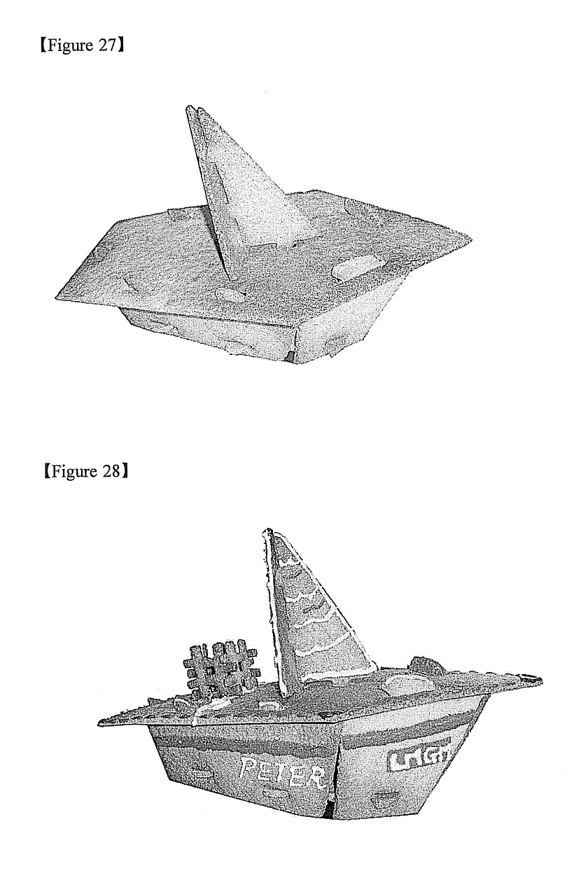

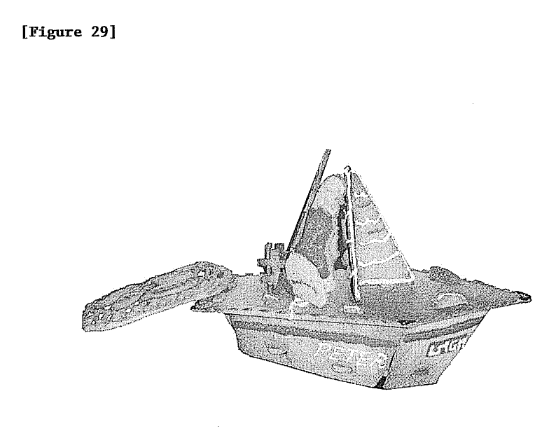

FIG. 27 illustrates the finished ship model produced by using a self-interlocking model kit according one embodiment of the present invention. According to the present invention, a ship model as well as a house model can be produced. Further, as shown in FIGS. 28 and 29, a high work level model can be produced.

### INDUSTRIAL APPLICABILITY

As described above, the present invention has the advantage of providing an edible panel and a self-interlocking model kit comprising edible panels, in which the edible panel can be freely molded when it is in a dough state but is transformed into a cookie, which is not deformed or molded, by calcining, in which the edible panel has a variety of sizes and shapes so as to be molded into a variety of models, such as a house or a ship, so that it gives people a chance to experience modeling, appreciate the model built by themselves, feel a sense of achievement and satisfaction, and have special cookies with unique appearances designed by themselves, and which can be used as celebration gifts. Accordingly, cookie makers can produce cookies using the edible panels and the self-interlocking model kit according to the present invention, so that cookie makers can increase sales revenue of the cookies.

1. An edible panel having at least one first coupling projection with a letter “L” shape.

2. The edible panel as claimed in claim 1, wherein the edible panel has at least one coupling hole into which the first coupling projection can be inserted.

3. The edible panel as claimed in claim 1, wherein the first coupling projection is formed at an edge portion thereof.

4. The edible panel as claimed in claim 1, wherein the edible panel further has a second coupling projection.

5. The edible panel as claimed in claim 4, wherein the second coupling projection is formed at an edge portion thereof.

6. A self-interlocking model kit comprising the edible panel as claimed in claim 1, wherein the edible panel is comprised of chocolate or a cookie, such as a biscuit made by mixing flour, which is the main ingredient, sugar, milk, egg and spices and baking the mixture.

7. A self-interlocking model kit comprising:
a first edible panel having at least one first coupling projection with a letter “L” shape; and
a second edible panel having at least one coupling hole into which the first coupling projection can be inserted.

8. The self-interlocking model kit as claimed in claim 7, wherein the first edible panel is an edible panel including at least one coupling hole into which the first coupling projection can be inserted.

9. The self-interlocking model kit as claimed in claim 7, wherein the second edible panel is an edible panel including at least one coupling hole into which the first coupling projection can be inserted.

10. The self-interlocking model kit as claimed in claim 7, wherein the second edible panel is comprised of chocolate or a cookie, such as a biscuit made by mixing flour, which is the main ingredient, sugar, milk, egg and spices and baking the mixture.

11. A self-interlocking model kit comprising:
a first edible panel having at least one first coupling projection with a letter “L” shape;
a second edible panel having at least one coupling hole into which the first coupling projection can be inserted; and
a third edible panel having a first coupling portion including at least two projections of a first projection and a second projection, and a first notch, and a second projection including at least two projections of a third projection and a fourth projection, a coupling jaw, and a second notch, wherein the coupling jaw, the third projection, the second notch and the fourth projection are disposed in order from the bottom of the second coupling portion.

12. The self-interlocking model kit as claimed in claim 11, wherein the third edible panel has at least two vertical poles and at least one horizontal pole, wherein one vertical panel has the first coupling portion being comprised of at least two projections, such as the first and second projections, and a notch formed between the two projections, and the other vertical panel has the second coupling portion being comprised of at least two projections, such as the third projection and the fourth projection, the second notch formed between the third and fourth projections and the coupling jaw disposed under the third projection.

13. The self-interlocking model kit as claimed in claim 11, wherein each of the first edible panel, the second edible panel and the third edible panel is comprised of chocolate or a cookie, such as a biscuit made by mixing flour, which is the main ingredient, sugar, milk, egg and spices and baking the mixture.

14. The edible panel as claimed in claim 2, wherein the first coupling projection is formed at an edge portion thereof.

15. The edible panel as claimed in claim 2, wherein the edible panel further has a second coupling projection.

16. A self-interlocking model kit comprising the edible panel as claimed in claim 2, wherein the edible panel is comprised of chocolate or a cookie, such as a biscuit made by mixing flour, which is the main ingredient, sugar, milk, egg and spices and baking the mixture.

17. The self-interlocking model kit as claimed in claim 12, wherein each of the first edible panel, the second edible panel and the third edible panel is comprised of chocolate or a cookie, such as a biscuit made by mixing flour, which is the main ingredient, sugar, milk, egg and spices and baking the mixture.
